(19) United States
(12) Patent Application Publication
(10) Pub. No.: US 2011/0146600 A1
(43) Pub. Date: Jun. 23, 2011

(54) METHOD OF COOLING A HIGH PRESSURE PLUNGER

(75) Inventors: Senthilkumar Rajagopalan, Edwards, IL (US); Alan R. Stockner, Metamora, IL (US); Tejas Mayavanshi, Bloomington, IL (US); Stephen R. Lewis, Chillicothe, IL (US)

(73) Assignee: Caterpillar Inc., Peoria, IL (US)

(21) Appl. No.: 12/642,246

(22) Filed: Dec. 18, 2009

(51) Int. Cl. F01P 1/06; F02M 59/44; F02M 37/04

(52) U.S. Cl. 123/41.31; 123/456; 123/495

(57) ABSTRACT

A pumping element for pressurizing a fluid within a fluid pump includes a plunger reciprocally disposed within a bore defined in a pump housing. The plunger and housing at least partially define a pressurization chamber into which fluid is pressurized. A flow path is defined between the plunger and the bore, the flow path permitting fluid to pass from the pressurization chamber during pressurization of fluid disposed therein. A weep annulus is formed between the plunger and the bore, the weep annulus being disposed adjacent to the bore and being part of a cooling circuit for the pumping element. The housing further defines cooling and drain passages which are in fluid communication with one another via the weep annulus. The plunger an bore are convectively cooled when cooling fluid is supplied to the weep annulus via the cooling passage and drained away via the drain passage.

### TECHNICAL FIELD

This patent disclosure relates generally to reciprocating piston pumps for fluids and, more particularly, to fuel pumps for use with internal combustion engines.

### BACKGROUND

Fluid pumps having pumping elements that include a plunger reciprocating within a bore formed in a barrel are known. The plunger's reciprocating motion is typically accomplished with a mechanism that moves the plunger with a rotating cam. Alternatively, the plunger may contact an outer portion of a rotating angled disk or swash-plate to provide a controlled variable displacement.

A fluid pump might include a plurality of plungers that pressurize a flow of fluid, typically oil or fuel, for use in an internal combustion engine. For example, a fuel injector might use the flow of pressurized fluid, from the pump to inject the fuel or to intensify the pressure of the fuel that is injected into the engine.

Modern fuel systems use progressively higher injection pressures for injecting fuel within the engine increase the efficiency of the engine and, potentially, reduce emissions. Nevertheless, issues are presented when attempting to increase the service pressure of a fluid pump. For example, increased service pressure increases the thermal load imparted to the plunger, bore surfaces, and other pump elements. In the past, various material and design limitations have generally limited pump outlet pressures because of such thermal effects experienced by various pumping elements.

Attempts to reach progressively higher injection pressures and dealing with increasing thermal loads is further constrained by consumer's desires to have smaller pumps. Dealing with thermal loads in smaller pumps is a more difficult task because there is simply less room to apply different cooling solutions. For example, in some midsized and smaller pumps, engineers have observed that as increasing pressures are reached, thermal gradients occur. These temperature gradients may lead to erratic pump behaviors. For example, pumps that have been operable for as little as 40 minutes may see a temperature gradient across a pump bore of 100° C. With one side of the pump bore being significantly hotter than the other, a bowing of the plunger bore may occur. This bowing effect is known as bore deformation. When this happens, the plunger, which moves within the bore in a substantially vertical reciprocating manner, may begin to start rubbing against the bore. Additionally, plunger scuffing may occur because excess heat within the plunger bore may cause the plunger to thermally expand and minimize the annular clearance of the plunger within the bore. The scuffing is caused by the plunger coming into repeated contact with the sides of the plunger bore. Plunger scuffing may lead to pump failure.

In the past, engineers have used alternate pump designs to address the internal cooling issues within pumps. These designs tend to focus on larger clearances between the plunger and the barrel of the pump. However, such clearances can reduce the pumping efficiency of the pump, increase leakage and potentially increase the temperature of the compressed fuel exiting the pump. Alternative cooling designs may utilize excess space around the plunger bore to create an annular reservoir where cooling fluid may pool and work to remove excess heat from plunger and plunger bore. However, as previously mentioned smaller pumps simply do not have the internal space to utilize these more complex cooling solutions. For example, there may be no room for a separate plunger barrel, let alone annular reservoirs therein. The subject matter of the present disclosure address one or more of the aforementioned issues.

### SUMMARY

In one aspect, a fuel pump including a housing defining a bore having a longitudinal centerline, an inlet port, an outlet port, a return gallery, and an inlet gallery in fluid communication with the inlet port. Also included is a plunger at least partially disposed within the bore, wherein the plunger arranged for reciprocal motion within the bore. The fuel pump further includes pressurization cavity at least partially defined between an end of the plunger and an end portion of the bore, wherein the pressurization cavity is adapted for pressurizing an amount of fuel supplied through the inlet gallery and provided to the outlet port during the pressurization stroke of the plunger. Also included is an annular clearance defined between an outer surface of the plunger and an inner surface of the bore, wherein the annular clearance is in fluid communication with the pressurization cavity. The fuel pump further includes a weep annulus defined around the inner surface of the bore, wherein the weep annulus surrounds a portion of the plunger and is in fluid communication with the annular clearance. A cooling supply passage defined by the housing fluidly coupling the inlet gallery and the weep annulus is also included. The fuel pump further includes a drain passage defined by the housing, wherein the drain passage fluidly couples the fuel return passage and the weep annulus.

In another aspect, an engine system including an internal combustion engine including an engine housing defining a plurality of engine cylinders, and including a plurality of pistons each being movable within a corresponding one of the engine cylinders. Also included is a fuel system including a fuel rail in fluid communication with a plurality of fuel injectors, wherein each fuel injector is associated with each of the plurality of engine cylinders. The fuel system further includes a fuel source, a transfer pump in fluid communication with the fuel source, and a high pressure pump in fluid communication with the transfer pump and the fuel rail. The high pressure pump further includes a housing defining a bore having a longitudinal centerline, an inlet port, an outlet port, a return gallery, and an inlet gallery in fluid communication with the inlet port. Also included is a plunger at least partially disposed within the bore, wherein the plunger arranged for reciprocal motion within the bore. The high pressure pump further includes pressurization cavity at least partially defined between an end of the plunger and an end portion of the bore, wherein the pressurization cavity is adapted for pressurizing an amount of fuel supplied through the inlet gallery and provided to the outlet port during the pressurization stroke of the plunger. Also included is an annular clearance defined between an outer surface of the plunger and an inner surface of the bore, wherein the annular clearance is in fluid communication with the pressurization cavity. The high pressure pump further includes a weep annulus defined around the inner surface of the bore, wherein the weep annulus surrounds a portion of the plunger and is in fluid communication with the annular clearance. A cooling supply passage defined by the housing fluidly coupling the inlet gallery and the weep annulus is also included. The high pressure pump further includes a drain passage defined by the housing, wherein the drain passage fluidly couples the fuel return passage and the weep annulus.

In another aspect, a method of operating a reciprocating plunger fluid pump. The fluid pump including at least one bore. The bore reciprocally accepting a plunger, the reciprocating motion of the plunger including a pressurization stroke and a refill stroke. The method includes a step of admitting an amount of fluid into a pressurization chamber during the refill stroke, wherein the pressurization chamber is at least partially defined between the plunger and the bore. The method further includes the step of pressurizing the fluid during the pressurization stroke. Also included is a step of weeping an amount of fluid out of the pressurization chamber and along an interface between the plunger and the bore. The method includes a step of collecting the weeping amount of fluid into a weep annulus, wherein the weep annulus is defined in the housing around a portion of the plunger adjacent to the bore. A step of admitting an amount of cooling fluid into the weep annulus via a cooling supply passage is also included. The method contemplates mixing the flow of cooling fluid with the fluid that weeps out of the pressurization chamber. A step of routing the mixed fluids out of the weep annulus through via a drain passage is also included. The method further includes a step of conducting heat away from the plunger.

### BRIEF DESCRIPTION OF THE DRAWINGS

FIG. 1 is schematic of an engine system having a fuel pump in accordance with the disclosure;

FIG. 2 is a cross section of a fluid pump in accordance with the disclosure;

FIG. 3 is a cross section of a fluid pump showing an embodiment of a cooling system in accordance with the disclosure;

FIG. 4 is a schematic of a fluid pump showing a parallel circuit of an embodiment of a cooling system in accordance with the disclosure;

FIG. 5 is a block diagram of an engine system having a high-pressure fuel pump associated therewith in accordance with the disclosure; and.

### DETAILED DESCRIPTION

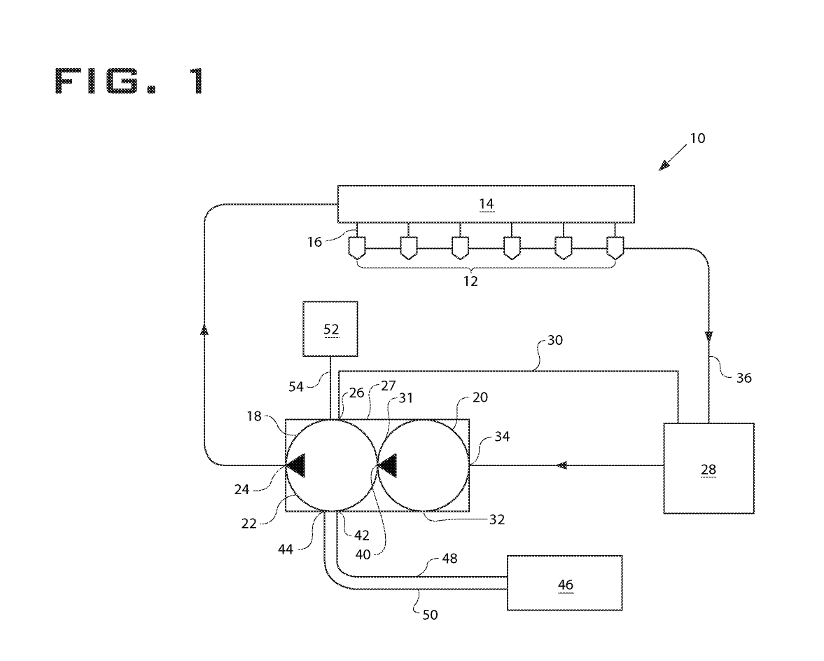

Referring to FIG. 1, there is shown a schematic illustration of an engine system 10 according to the present disclosure. The engine system 10 includes a plurality of injectors 12, which are each connected to a high pressure fuel rail 14 via individual branch passages 16. The high pressure fuel rail 14 is supplied with high pressure fuel from a high pressure pump 18 that is supplied with relatively low pressure fuel by a low pressure pump 20. A high pressure pump housing 22 of the high pressure pump 18 defines a high pressure pump outlet 24 fluidly connected to the high pressure fuel rail 14 and a return line outlet 26 fluidly connected to a fuel tank 28, via a first return line 30. A low pressure pump housing 32 of the low pressure pump 20 defines a low pressure pump inlet 34 fluidly connected to the fuel tank 28, which is also fluidly connected to the fuel injectors 12 via a second return line 36. Although the present disclosure contemplates the high pressure pump 18 and the low pressure pump 20 being separate from one another in separate housings, in the illustrated embodiment, the low pressure pump 20 and the high pressure pump 18 may be both included within a compound pump assembly 27. The high pressure pump housing 22 of the high pressure pump 18 may be attached to the low pressure pump housing 32 of the low pressure pump 20 in a conventional manner, such as through the use of bolts. The low pressure pump housing 32 defines a low pressure pump outlet 38 that is fluidly connected to a high pressure pump inlet 40 defined by the high pressure pump housing 22. The high pressure pump housing 22 also defines a lubrication fluid inlet 42 and a lubrication fluid outlet 44. The lubrication fluid inlet 42 and the lubrication fluid outlet 44 are fluidly connected to a source of lubrication fluid 46, illustrated as an engine oil sump, via a lubrication supply line 48 and a lubrication return line 50, respectively. A pump (not shown) may be provided to draw lubrication fluid from the source of lubrication fluid 46 and pressurize the lubrication fluid for transport to the lubrication fluid inlet 42.

The engine system 10 is controlled in its operation in a conventional manner via an electronic control module 52 which is connected to the high pressure pump 18 via a pump communication line 54 and connected to each fuel injector 12 via communication lines (not shown). When in operation, control signals generated by the electronic control module 52 determine how much fuel displaced by the high pressure pump 18 is forced into the high pressure fuel rail 14 and at what time, as well as when and for what duration (indicative of fuel injection quantity) fuel injectors 12 operate. The fuel not delivered to the high pressure fuel rail 14 can be re-circulated back to the fuel tank 28 via the first return line 30.

For the most part, fuel that is provided to the high pressure pump 18 is ultimately either injected via fuel injectors 12 into engine cylinders (not shown) or it is returned to fuel tank 28. Fuel that is injected is routed through the high pressure pump 18 to a pressurization chamber (not shown) where it is pressurized via plunger (not shown) and provided to the high pressure fuel rail 14. The other fuel that is provided to the high pressure pump 18 ultimately ends up back at the fuel tank 28. As discussed in greater detail below, this fuel is either utilized as cooling fluid, whereby it is routed through a cooling circuit within the high pressure pump, or it is collected as excess and/or leakage and then sent back to the fuel tank 28.

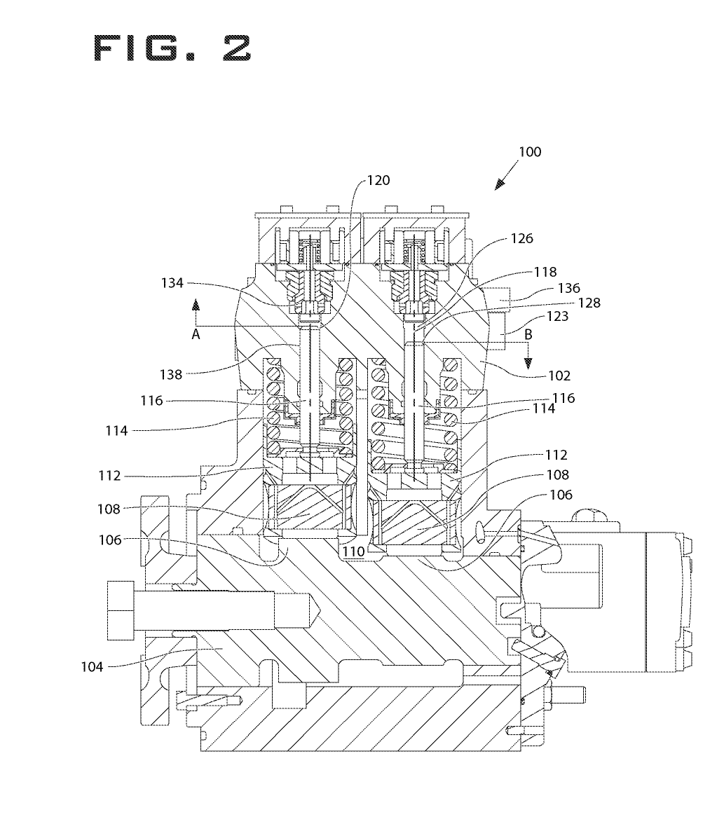

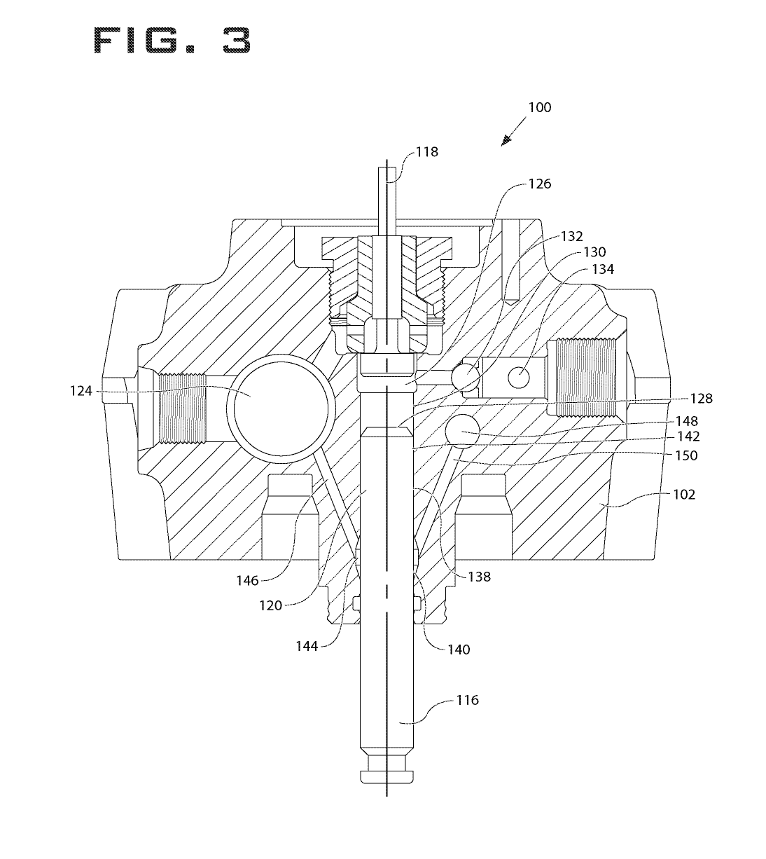

Various views of a first embodiment for a fluid pump 100 in accordance with the disclosure are shown in FIG. 2 through FIG. 4. FIG. 2 is a partial cross section of the pump 100. An internal view of a portion of the housing 102 of the pump showing fluid passages defined therein is shown in the enlarged detail of FIG. 2. FIG. 3 is a cross section of an embodiment for a pumping element. The pump 100 presented herein is arranged for pumping fuel into a common rail (not shown) that supplies pressurized fuel to one or more fuel injectors (not shown) during operation of an engine (not shown), and is used to illustrate the structure of the pumping elements by way of example. As can be appreciated, the structures described herein can advantageously be used on any type of fluid pump having a fixed or variable displacement.

The pump 100 uses oil for lubrication of various moving parts. Other types of pumps may use fuel for lubrication or, alternatively, be arranged to pump oil instead of fuel for use with intensified or hybrid fuel systems. The pump 100 described herein is presented solely for illustrative purposes and should not be construed as limiting.

The pump 100 includes a base or outer structure or housing, generally denoted in the figures as 102. The housing 102 may include one or more connected components forming a structure that encloses and supports various internal components of the pump. In this exemplary representation, the housing 102 includes a cam or drive shaft 104 having one or more eccentric lobes 106. Each lobe 106 corresponds to an actuator 108 that moves reciprocally along an outer race 110 of each lobe 106 as the shaft 104 rotates. Each actuator 108 contacts a lifter 112. The lifter 112 continuously contacts its respective outer race 110 by action of a resilient element or spring 114. The spring 114 pushes the lifter 112 against the actuator 108 to ensure that the reciprocating motion of the actuator 108 is transferred to the lifter 112 while the shaft 104 is rotating.

A plunger 116 is operatively connected to the lifter 112 such that the plunger 116 can reciprocate as the shaft 104 rotates. The plunger 116 has a cylindrical shape with a centerline 118 extending along its major dimension. During operation of the pump 100, the plunger 116 reciprocates along its centerline 118 within a bore 120 defined by the housing 102. The bore 120 is arranged to have a centerline extending axially or longitudinally along the bore 120. The centerline of the bore substantially coincides with the centerline 118 of the plunger 116. During operation of the pump 100, the plunger 116 moves between an extended position, A, during a pressurization stroke, and a retracted position, B, during a filling stroke.

An inlet port 123 allows fuel from an inlet gallery 124 of the pump 100 to enter a pressurization chamber 126. The pressurization chamber 126 is at least partially defined between a distal end 128 of the plunger 116 (also see FIG. 3), a portion 130 of the housing 102, and an outlet check valve 132. Fuel present in the pressurization chamber 126 becomes pressurized when the plunger 116 moves from the retracted position B to the extended position A. Once the pressure of the fuel is sufficiently high, for example, between 1700 and 2200 bar or more, the outlet check valve 132 opens to allow the pressurized fuel to exit the pressurization chamber 126 through one or more respective openings 134. Pressurized fuel exiting through each opening 134 is collected and routed to an outlet port 136 of the pump 100.

As can be appreciated, a proper clearance is required between the plunger 116 and the bore 120 that can seal the interface there between to promote proper pressurization of the fluid in the pressurization chamber 126, as well as accommodate for thermal expansion of the plunger 116 relative to the housing 102. This annular clearance, generally shown as 138, is defined between an outer surface 140 of the plunger 116 and an inner surface 142 of the bore 120. Smaller clearances, which allow for greater pressurization capability for the pump 100, negatively affect the freedom of motion and thermal expansion of the plunger 116 within the bore 120. On the other hand, while larger clearances cause reductions in the efficiency of the pump.

Further, appreciable heating of the plunger 116 during operation of the pump 100 occurs due to heat transfer from the pressurized fluid within the pressurization chamber 126. A detailed cross section of housing 102 containing the plunger 116 is shown in FIG. 3. Fluid escaping from the pressurization chamber 126 during the pressurization stroke of the plunger 116 through the annular clearance 138 is collected in a weep annulus 144. The weep annulus 144 is an annular cavity that is formed in the housing 102 around a portion of the bore 120. The weep annulus 144 fluidly communicates with the pressurization chamber 126 through the annular clearance 138 such that fluid flowing or weeping along the plunger 116 within the annular clearance 138 is collected in the weep annulus 144 and is not allowed to continue flowing along the plunger 116 to eventually seep out between the housing 102 and the plunger 116. Because the weeping fluid acts to heat the plunger in areas thereof it contacts, a temperature gradient is created in the plunger and housing above and below the weep annulus 144.

The weep annulus 144 is in fluid communication with an fuel in the inlet gallery 124 via a cooling passage 146 that is defined by housing 102. When plunger 116 is retracting during a filling stroke, a localized vacuum may be formed in weep annulus 144. Thus, a portion of the fuel from the inlet port, which is above ambient pressure, flows into the weep annulus 144 via cooling passage 146. In this manner, relatively cool fuel from the inlet gallery 124 mixes with fuel that weeps into the weep annulus 144 from the pressurization chamber 126 via the annular clearance 138. Because the fuel from inlet port 144 is cooler than the fuel from the pressurization chamber 126, the aforementioned temperature gradient between plunger and the housing may be alleviated. During the pressurization stroke of the plunger 116, the pressure within weep annulus is increased. This pressure increase is still lower than the approximately ambient pressure of the fuel in inlet port 144, but it is higher than the pressure within a return gallery 148. Return gallery 148 is in fluid communication with weep annulus 144 via a drain passage 150, which is defined by housing 102. Thus, during the pressurization stroke, fuel within the weep annulus 144 is pumped through the drain passage 150 to return gallery 148. From here, the fuel exits pump 100 and is returned to fuel tank (not shown). Those skilled in the art will recognize that in some embodiments, the fuel that leaves the return gallery 148 may be routed directly back to the inlet gallery 124 without returning to fuel tank (not shown). Such embodiments do not depart from the scope of the present disclosure.

As can be appreciated, a thermal gradient will be present in both the housing 102 and plunger 116 during operation of the pump. This thermal gradient results from heating of the fuel being pressurized in the pressurization chamber 126. Heat transferred from the pressurized fuel tends to heat the portions of the housing 102 and plunger 116 that surround the pressurization chamber 126. Heat conductively travels through the components toward the fuel to oil interface of the pump. The thermal gradients may cause differing degrees of thermal expansion between the plunger 116 and the housing 102, which may in turn cause dimensional clearance issues there between during operation of the pump. These issues become relevant to the operation of the pump when present in the region that lies proximate to the fuel to oil interface and, more specifically, in the portion of the housing 102 extending between the weep annulus 144 and the fuel to oil interface.

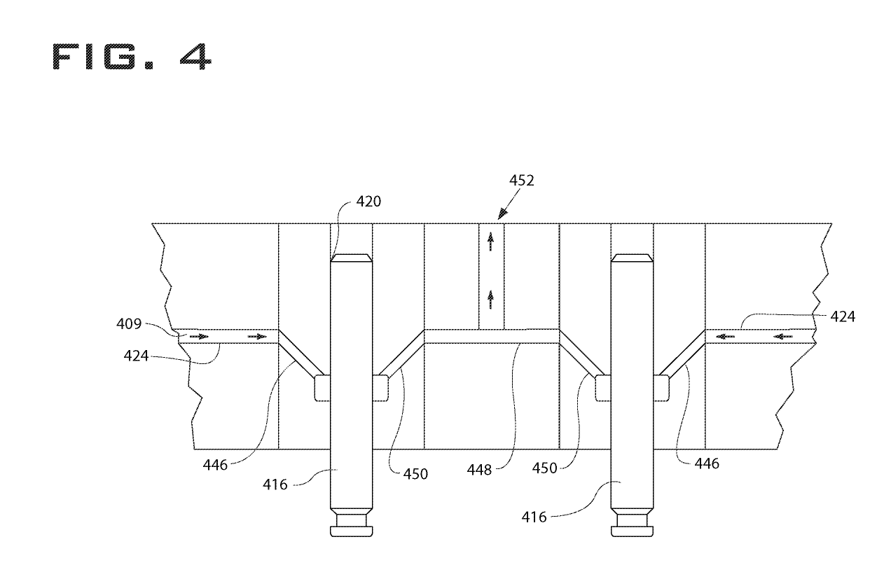

A schematic of a fluid pump showing a cross section of two adjacent plungers 416 disposed in respective bores 420 of a fluid pump is shown in FIG. 4. The bores 420 of this embodiment are similar in structure to the bores discussed in the first embodiment shown in FIGS. 2 and 3. In this embodiment, a flow of cooled fluid 409, denoted generally by dotted-line arrows, is also supplied into each weep annulus 444 via a cooled fluid supply passage 446. FIG. 4 shows a parallel cooling circuit connection wherein the flow from inlet gallery 424 is supplied to the weep annulus 444 via cooling passages 446. The flow supplied to the weep annulus 444 convectively cools the bore 420. The heat removed from the bore 420 increases the temperature difference between the bore 420 and the plunger 416, which in turn increases the heat flowing out of the plunger 416. The heat outflow from the plunger 416 reduces the plunger's temperature, which eventually reduces or eliminates the temperature differentials between the plunger 416 and the bore 420. As shown in FIG. 4, the flow of cooled fluid 409 then travels to return gallery 448 via drain passages 450. From here, the fuel may exit the pump through fuel exit 452 where it may be returned to a fuel tank (not shown). Alternatively, after leaving fuel exit 452, the fuel may be routed back to inlet gallery 424. In an alternate embodiment, the flow of cooled fluid 409 may be supplied in series circuit connection where it is supplied to each respective bore sequentially.

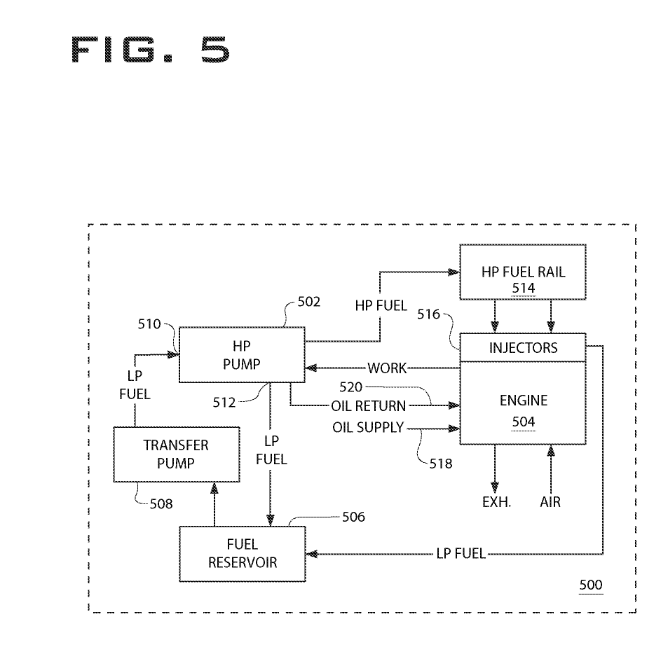

During operation of the pump, a flow of cooling fuel is provided to the pump via the low pressure pump 20. Such flow may be part of a main fuel flow to the pump that is compressed and provided to the fuel injectors (see, for example, the illustration of FIG. 5), or may alternatively be provided as part of a separate cooling circuit that includes a fuel cooler or other devices. In embodiments for fuel pumps that include more than one pumping elements, the flow of cooling fuel may sequentially pass through each pumping element in parallel, as is illustrated in FIG. 4, or may alternatively by provided sequentially to all pumping elements in a series circuit configuration.

### INDUSTRIAL APPLICABILITY

The present disclosure is applicable to a fluid pump having one or more reciprocating plungers that can pressurize a fluid to levels that were previously unattainable by use of known pumping systems. The embodiments disclosed herein are advantageously suited for implementation in fluid pumps that are capable of prolonged and reliable operation under high-pressure transient and steady-state conditions. Pumps in accordance with the disclosure are advantageously capable of achieving outlet pressures in the range of 1700 to 2200 bar or higher. This advantageous operation is enabled because of the improved management of heat transferred between the pumping elements.

Moreover, active cooling of elements, for example as shown for the second and third embodiments, further aid in lowering the overall temperatures of the plunger, barrel, and other components of the pump. Further, reduction of the overall mass of the barrels of the three embodiments presented lowers the thermal capacity of each barrel such that the temperature of the barrel tracks the temperature of the plunger, which is especially useful during transient changes in the operation of the pump.

A block diagram for an engine system 500 having a high-pressure (HP) fuel pump 502 operatively associated therewith is shown in FIG. 5. The engine system 500 includes an internal combustion engine 504 connected with the HP pump 502. The engine 504 may be a compression ignition or diesel engine that receives air and fuel into a plurality of combustion chambers during operation. Fuel at a low-pressure (LP) is supplied to the HP pump 502 from a tank or reservoir 506. The reservoir 506 is connected to a transfer or low-pressure pump 508 that operates to pump fuel out of the reservoir 506 and supply the fuel to the HP pump 502 through the supply inlet port 510 thereof. The return outlet port 512 of the HP pump 502 is connected to the reservoir 506 such that LP fuel exiting the HP pump 502, for example, fuel exiting the annular reservoir(s) of the HP pump 502 as described above, returns to the reservoir 506.

During operation of the engine 504, a work output from the engine 504 operates the HP pump 502. A flow of pressurized fuel (HP Fuel) exits the HP pump 502 and is delivered to the engine 504. For example, the flow of HP fuel may be delivered to a HP fuel rail 514 that is connected to a plurality of fuel injectors 516, which are integrated with the engine 504. A flow of unused fuel from the fuel injectors 516 may return to the reservoir 506. In this exemplary illustration, the HP pump 502 uses lubrication oil from the engine 504 for lubrication of internal moving components, such as, the actuators and lifters (not shown) that contact the drive shaft (not shown) of the HP pump 502. For this purpose, an oil supply line 518 acts in conjunction with an oil return line 520 to circulate a flow of lubrication oil between the engine 504 and the HP pump 502. As can be appreciated, the engine system 500 as described herein is suited for use in a vehicle having the engine 504 arranged to drive and power various systems on the vehicle.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A fuel pump comprising:
a housing defining a bore having a longitudinal centerline, an inlet port, an outlet port, a return gallery, and an inlet gallery in fluid communication with the inlet port;
a plunger at least partially disposed within the bore, the plunger arranged for reciprocal motion within the bore;
a pressurization cavity at least partially defined between an end of the plunger and an end portion of the bore, the pressurization cavity adapted for pressurizing an amount of fuel supplied through the inlet gallery and provided to the outlet port during the pressurization stroke of the plunger;
an annular clearance defined between an outer surface of the plunger and an inner surface of the bore, the annular clearance in fluid communication with the pressurization cavity;
a weep annulus defined around the inner surface of the bore, the weep annulus surrounding a portion of the plunger, the weep annulus in fluid communication with the annular clearance;
a cooling supply passage defined by the housing fluidly coupling the inlet gallery and the weep annulus;
a drain passage defined by the housing fluidly coupling the fuel return passage and the weep annulus.

2. The fuel pump of claim 1, wherein a path for a flow of fuel begins from the cooling supply passage, terminates at the return passage, and extends through the weep annulus.

3. An engine system comprising:
An internal combustion engine including an engine housing defining a plurality of engine cylinders, and including a plurality of pistons each being movable within a corresponding one of the engine cylinders;
A fuel system including a fuel rail in fluid communication with a plurality of fuel injectors, wherein each fuel injector is associated with each of the plurality of engine cylinders, and said fuel system further comprising:
a fuel source;
a transfer pump in fluid communication with the fuel source;
a high pressure pump in fluid communication with the transfer pump and the fuel rail, said high pressure pump further comprising:
a housing defining a bore having a longitudinal centerline, an inlet port, an outlet port, a return gallery, and an inlet gallery in fluid communication with the inlet port;
a plunger at least partially disposed within the bore, the plunger arranged for reciprocal motion within the bore;
a pressurization cavity at least partially defined between an end of the plunger and an end portion of the bore, the pressurization cavity adapted for pressurizing an amount of fuel supplied through the inlet gallery and provided to the outlet port during the pressurization stroke of the plunger;
an annular clearance defined between an outer surface of the plunger and an inner surface of the bore, the annular clearance in fluid communication with the pressurization cavity;
an weep annulus defined around the inner surface of the bore, the weep annulus surrounding a portion of the plunger, the weep annulus in fluid communication with the annular clearance;
a cooling supply passage defined by the housing fluidly coupling the inlet gallery and the weep annulus;
a drain passage defined by the housing fluidly coupling the fuel return passage and the weep annulus.

4. The engine system of claim 1, wherein a path for a flow of fuel within the high pressure pump begins from the cooling supply passage, terminates at the return passage, and extends through the weep annulus.

5. A method of operating a reciprocating plunger fluid pump, the fluid pump including at least one bore, the bore reciprocally accepting a plunger, the reciprocating motion of the plunger including a pressurization stroke and a refill stroke, the method comprising:
admitting an amount of fluid into a pressurization chamber during the refill stroke, the pressurization chamber at least partially defined between the plunger and the bore;
pressurizing the fluid during the pressurization stroke;
weeping an amount of fluid out of the pressurization chamber and along an interface between the plunger and the bore;
collecting the weeping amount of fluid into a weep annulus, the weep annulus defined in the housing around a portion of the plunger adjacent to the bore;
admitting an amount of cooling fluid into the weep annulus via a cooling supply passage;
mixing the flow of cooling fluid with the fluid that weeps out of the pressurization chamber;
routing the mixed fluids out of the weep annulus through via a drain passage; and
conducting heat away from the plunger.
